(19) United States
(12) Patent Application Publication
(10) Pub. No.: US 2022/0266756 A1
(43) Pub. Date: Aug. 25, 2022

(54) STORAGE SYSTEM FOR VEHICLE

(71) Applicant: Ford Global Technologies, LLC, Dearborn, MI (US)

(72) Inventors: Michael Harmon, Westland, MI (US); Gabriella Jacobsen, Ferndale, MI (US); Carlos Gonzales, Berkley, MI (US); Michael Huskey, Farmington, MI (US); Arnav Wagh, Detroit, MI (US); Daveanand M. Singh, Detroit, MI (US); Ryan Christiansen, Grosse Ile, MI (US)

(73) Assignee: Ford Global Technologies, LLC, Dearborn, MI (US)

(21) Appl. No.: 17/184,650

(22) Filed: Feb. 25, 2021

(51) Int. Cl. B60R 7/02

(52) U.S. Cl. CPC B60R 7/02

(57) ABSTRACT

A storage system for a vehicle is provided that includes a track assembly disposed on a vehicle floor that includes a first track disposed transverse to a second track, a plurality of containers positionable in an engaged position or a disengaged position relative to the track assembly and each including one or more square-shaped top portions.

### FIELD OF THE DISCLOSURE

The present disclosure generally relates to storage enclosures and more specifically to arrangements of multiple containers in vehicles.

### BACKGROUND OF THE DISCLOSURE

Convenient access to vehicle cargo has become increasingly important as passengers seek user friendly cargo stowage options. Convenient movement of cargo within a vehicle is paramount for satisfying customer needs. Efficient cargo storage in available vehicle space improves customer satisfaction.

### SUMMARY OF THE DISCLOSURE

According to a first aspect of the present disclosure, a storage system for a vehicle is provided. The storage system includes a track assembly disposed on a vehicle floor that includes a first track disposed transverse to a second track. The storage system further includes a plurality of containers positionable in an engaged position or a disengaged position relative to the track assembly and each includes one or more square-shaped top portions.

Embodiments of the first aspect of the present disclosure can include any one or a combination of the following features:
the plurality of containers are positionable in a planar arrangement substantially parallel to the vehicle floor;
an attachment location disposed at an intersection of the first track and the second track;
a track attachment feature disposed at the attachment location;
the track attachment feature includes one or more attachment zones;
each of the one or more attachment zones is configured to receive a foot of one of the plurality of containers;
each of the plurality of containers includes a lower attachment feature positionable in an engaged position or a disengaged position relative to the track attachment feature;
each of the plurality of containers includes an upper attachment feature;
the upper attachment feature is substantially similar to the track attachment feature;
each of the plurality of containers having the upper attachment feature defines a plurality of first containers disposed in a first planar arrangement of first containers coupled to the track assembly, and further comprising a plurality of second containers disposed in a second planar arrangement of second containers;
the second planar arrangement of second containers is disposed on top of the first planar arrangement of first containers;
each of the plurality of second containers disposed in the second planar arrangement of second containers include a lower attachment feature that is positionable in an engaged position or a disengaged position relative to the upper attachment feature disposed on each of the plurality of first containers disposed in the first planar arrangement of first containers; and/or
each of the plurality of first containers disposed in the first planar arrangement of first containers are slidable along the track assembly.

According to a second aspect of the present disclosure, a storage system for a vehicle is provided. The storage system includes a first container, a track assembly having a plurality of attachment zones arranged in a grid-like formation for receiving the first container, and a first attachment mechanism disposed between the first container and the track assembly, wherein the first attachment mechanism includes a lower attachment feature disposed on the first container and a track attachment feature disposed in the track assembly, wherein the first attachment mechanism may be in an engaged position to secure the first container to the track assembly, and wherein the first attachment mechanism may be in a disengaged position to release the first container from the track assembly.

Embodiments of the second aspect of the present disclosure can include any one or a combination of the following features:
a second container disposed on top of the first container, and a second attachment mechanism disposed between the first container and the second container and movable between an engaged position to secure the second container to the first container and a disengaged position to release the second container from the first container;
the first container is one of a plurality of first containers disposed in a first planar arrangement on the track assembly, wherein the second container is one of a plurality of second containers disposed in a second planar arrangement above the first planar arrangement, and wherein the first container and the second container are the same size and shape;
a panel disposed on a vehicle floor defines the track assembly; and/or
a first track assembly defined by the first planar arrangement, and a second track assembly defined by the second planar arrangement.

According to a third aspect of the present disclosure, a storage system for a vehicle is provided. The storage system includes a plurality of first containers arranged in a first planar arrangement in a vehicle cargo area which include a first container lower attachment feature and a first container upper attachment feature. The storage system further includes a plurality of second containers arranged in a second planar arrangement in a vehicle cargo area which include a second container lower attachment feature and a second container upper attachment feature. The storage system further includes a panel including a track assembly disposed in the vehicle which includes attachment locations for receiving the plurality of first containers on the track assembly in engaged positions, wherein the plurality of first containers in disengaged positions are movable along the track assembly and between the attachment locations.

Embodiments of a third aspect of the present disclosure can include any one or a combination of the following features:
the track assembly and the attachment locations are arranged in a grid-like formation.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a vehicle interior with a vehicle floor and containers, according to an aspect of the disclosure;

FIG. 2A is a perspective view of a container including one square-shaped top portion, according to an aspect of the disclosure;

FIG. 2B is a perspective view of a container including two square-shaped top portions, according to an aspect of the disclosure;

FIG. 2C is a perspective view of a container including four square-shaped top portions arranged in a line, according to an aspect of the disclosure;

FIG. 2D is a perspective view of a container including four square-shaped top portions arranged in a square, according to an another aspect of the disclosure;

FIG. 2E is a perspective view of a container including six square-shaped top portions arranged in a rectangle, according to an aspect of the disclosure;

FIG. 2F is a perspective view of a container including twelve square-shaped top portions arranged in a rectangle, according to an aspect of the disclosure;

FIG. 3A is a perspective view of a panel including a track assembly, according to an aspect of the disclosure;

FIG. 3B is a perspective view of a panel including a track assembly, according to another aspect of the disclosure;

FIG. 3C is a perspective view of a panel including a track assembly, according to yet another aspect of the disclosure;

FIG. 4 is a perspective view of a panel including a track assembly and containers arranged in a planar arrangement, according to an aspect of the disclosure;

FIG. 5 is a perspective view of a panel including a track assembly and a container including two square-shaped top portions, according to an aspect of the disclosure;

FIG. 6 is a perspective view of a panel including a track assembly and a container including six square-shaped top portions, according to an aspect of the disclosure;

FIG. 7 is a perspective view of a panel including a track assembly, a container including four square-shaped top portions, and a container including one square-shaped top portion, according to an aspect of the disclosure;

FIG. 8 is a perspective view of a panel including a track assembly, a container including two square-shaped top portions and a container including twelve square-shaped top portions disposed in a planar arrangement, and a container including two square-shaped top portions disposed in another planar arrangement, according to an aspect of the disclosure;

FIG. 9A is a perspective view of an exemplary container with a square-shaped top portion, according to an aspect of the disclosure;

FIG. 9B is a side view of an exemplary storage system with a portion of a panel, two containers disposed in a first planar arrangement, a container disposed in a second planar arrangement, and containers disposed in additional planar arrangements according to an aspect of the disclosure;

FIGS. 10A-10E are various views of a storage system including a magnetic attachment mechanism, according to an aspect of the disclosure;

FIG. 10A is a perspective view of a container including magnetic lower attachment features and a track assembly including metallic track attachment features, according to an aspect of the disclosure;

FIG. 10B is a side elevational view of a track assembly including metallic track attachment features, two containers having magnetic lower attachment features and metallic upper attachment features, and a portion of a container having magnetic lower attachment features, according to an aspect of the disclosure;

FIG. 10C is a side perspective view of a lid of a container including metallic upper attachment features, according to an aspect of the disclosure;

FIG. 10D is a bottom perspective view of a portion of a container including magnetic lower attachment features, according to an aspect of the disclosure;

FIG. 10E is a bottom perspective view of a portion of a track assembly including metallic track attachment features, according to an aspect of the disclosure;

FIGS. 11A-11E are various views of a storage system including track attachment features having T-shaped slots and lower attachment features including feet with flanges, according to an aspect of the disclosure;

FIG. 11A is perspective view of a container including lower attachment features with flanges and track attachment features with T-shaped slots, according to an aspect of the disclosure;

FIG. 11B is a side elevational view of a track assembly including track attachment features with T-shaped slots, two containers having a lower attachment features including feet with flanges and upper attachment features including T-shaped slots, and a portion of a container having lower attachment features including feet with flanges, according to an aspect of the disclosure;

FIG. 11C is a top perspective view of a portion of a container including upper attachment features with portions of T-shaped slots, according to an aspect of the disclosure;

FIG. 11D is a bottom perspective view of a portion of a container including lower attachment features including feet with flanges, according to an aspect of the disclosure;

FIG. 11E is a perspective view of a track assembly including track attachment features having T-shaped slots, according to an aspect of the disclosure;

FIGS. 12A-12F are various views of a storage system including lower attachment features having clip locks and track attachment features having hook tabs, according to an aspect of the disclosure;

FIG. 12A is a perspective view of a container including lower attachment features having clip locks and track attachment features having hook tabs, according to an aspect of the disclosure;

FIG. 12B is a side elevational view of a container including a lower attachment features having clip locks and an upper attachment features having a hook tabs, track attachment features having a hook tabs, and a portion of a container having lower attachment features with clip locks, according to an aspect of the disclosure;

FIG. 12C is a perspective view of container including lower attachment features having clip locks, according to an aspect of the disclosure;

FIG. 12D is a top perspective view of a portion of a container with upper attachment features including hook tabs, according to an aspect of the disclosure;

FIG. 12E is a bottom perspective view of a portion of a container with lower attachment features including clip locks, according to an aspect of the disclosure;

FIG. 12F is a top perspective view of track attachment features having hook tabs, according to an aspect of the disclosure;

FIGS. 13A-13E are various views of a storage system including lower attachment features having spring-loaded pins and track attachment features having holes for receiving the spring-loaded pins, according to an aspect of the disclosure;

FIG. 13A is a perspective view of a container including lower attachment features having spring-loaded pins and track attachment features having a holes for receiving the spring-loaded pins, according to an aspect of the disclosure;

FIG. 13B is a side elevational view of two containers with lower attachment features having spring-loaded pins and upper attachment features having holes, a portion of a container including lower attachment features with spring-loaded pins, and track attachment features including holes, according to an aspect of the disclosure:

FIG. 13C is a top perspective view of a portion of a container including upper attachment features having holes, according to an aspect of the disclosure;

FIG. 13D is a perspective view of a portion of container including lower attachment features having spring-loaded pins, according to an aspect of the disclosure;

FIG. 13E is a perspective view of track attachment features including holes, according to an aspect of the disclosure;

FIGS. 14A-14E are various views of a storage system including lower attachment features having feet and track attachment features including detents, according to an aspect of the disclosure;

FIG. 14A is a perspective view of a container including lower attachment features having feet and track attachment features including detents, according to an aspect of the disclosure;

FIG. 14B is a side elevational view of two containers including lower attachment features having feet, track attachment features including detents, and a portion of a container with lower attachment features including feet, according to an aspect of the disclosure;

FIG. 14C is a top perspective view of a container including upper attachment features including a detent, according to an aspect of the disclosure;

FIG. 14D is a bottom perspective view of a container including lower attachment features having feet, according to an aspect of the disclosure;

FIG. 14E is a perspective view of a panel having track attachment features including detents, according to an aspect of the disclosure;

FIGS. 15A-15B are views of a storage system including a container having lower attachment features including charge receivers and track attachment features including charging features, according to an aspect of the disclosure;

FIG. 15A is a perspective view of a container including lower attachment features having charge receivers, according to an aspect of the disclosure;

FIG. 15B is a perspective view of track attachment features having charging features, according to an aspect of the disclosure;

FIG. 16 is a perspective view of a tile, according to an aspect of the disclosure;

FIGS. 17A-17H are various views of an exemplary storage system with exemplary dimensions, according to an aspect of the disclosure;

FIG. 17A is a perspective view of an exemplary container with a square-shaped top portion, according to an aspect of the disclosure;

FIG. 17B is a side elevational view of an exemplary storage system with a portion of a panel, two containers disposed in a first planar arrangement, and a container disposed in a second planar arrangement, according to an aspect of the disclosure;

FIG. 17C is a top elevational view of the container of FIG. 17A, according to an aspect of the disclosure;

FIG. 17D is a top elevational view of a container including two square-shaped top portions, according to an aspect of the disclosure;

FIG. 17E is a top elevational view of a container including four square-shaped top portions arranged in a square, according to an aspect of the disclosure;

FIG. 17F is a top elevational view of container including six square-shaped top portions arranged in a rectangle, according to an aspect of the disclosure;

FIG. 17G is a perspective view of a container including four square-shaped top portions arranged in a line, according to an aspect of the disclosure; and

FIG. 17H is a top elevational view of a container including twelve square-shaped top portions arranged in a rectangle, according to an aspect of the disclosure.

### DETAILED DESCRIPTION

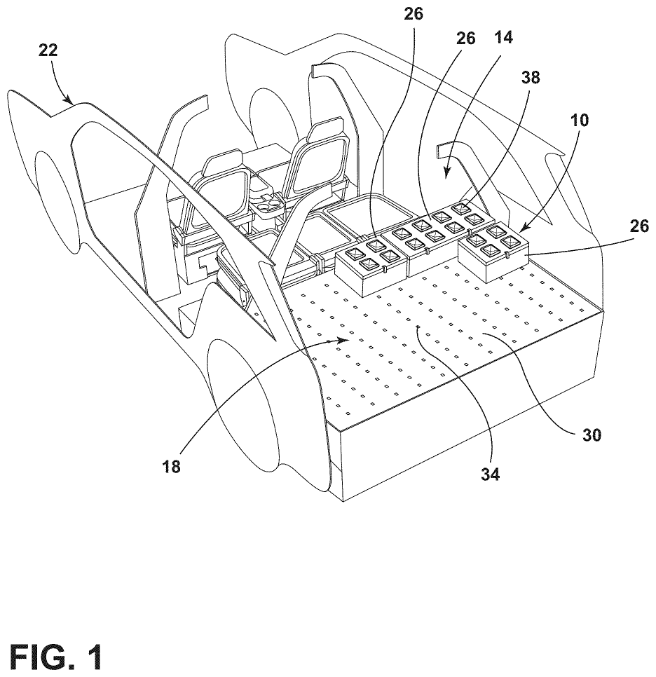

Referring to FIG. 1, a storage system 10 may be disposed in a vehicle interior 14. The storage system 10 may be disposed in a cargo area 18 of a vehicle 22. In the aspect shown, the storage system 10 is disposed in the rear of a vehicle 22. The storage system 10 may include containers 26 arranged on the vehicle floor 30. The containers 26 may be arranged on a grid-like formation 34 disposed in the vehicle floor 30. The containers 26 may include square-shaped top portions 38.

The storage system 10 may enhance the comfort of a vehicle user. The storage system 10 may provide containers 26 for separating and organizing vehicle cargo. The storage system 10 may allow cargo to be secured within containers 26 during vehicle operation. Containers 26 may be secured to a vehicle floor 30 and/or one another. The storage system 10 may allow a user to conveniently move and slide cargo within the vehicle 22 while minimizing lifting of cargo. The storage system 10 may include containers 26 that may be easily moved into and out of the vehicle 22. Containers 26 may be packed outside of a vehicle 22, placed into the vehicle 22, transported in the vehicle 22, removed from the vehicle 22, and unpacked outside of the vehicle 22.

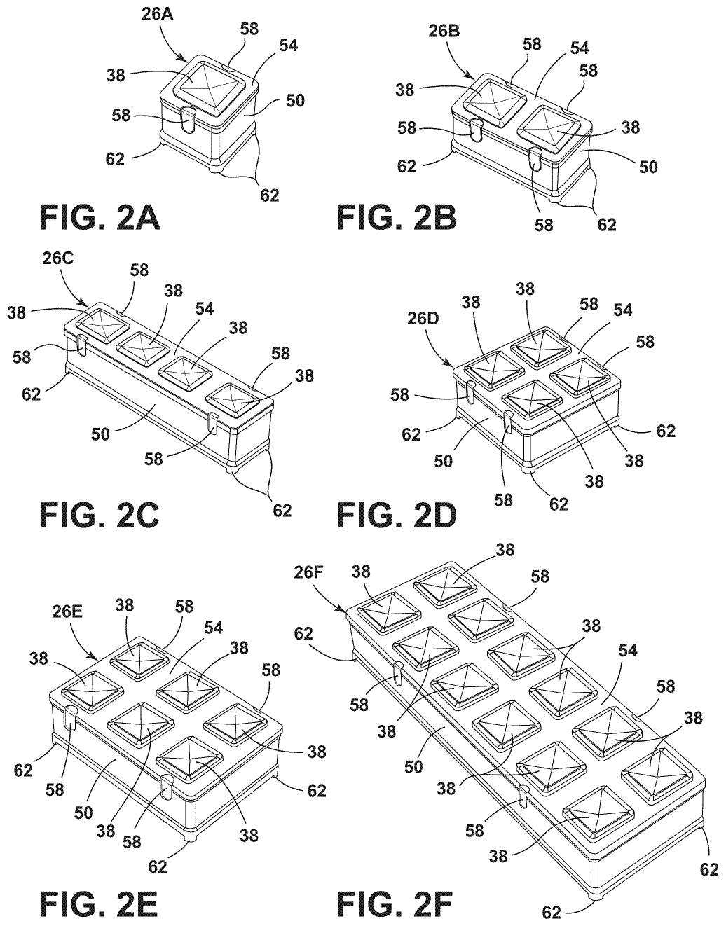

Referring now to FIGS. 2A-2F, the storage system 10 may include containers 26 that may be positioned in an engaged position VI or a disengaged position V relative to a track assembly 74. A container 26 may include one or more square-shaped top portions 38. The containers 26 may include bins 50 and lids 54. Fasteners 58 may secure the lids 54 to the bins 50. The fasteners 58 may be referred to as handles. Feet 62 may be disposed at the bottoms of the bins 50. Referring to FIG. 2A, a container 26A may include one square-shaped top portion 38. Referring to FIG. 2B, a container 26B may include two square-shaped top portions 38. Referring to FIG. 2C, an elongated container 26C may include four square-shaped top portions 38 arranged in a line. Referring to FIG. 2D, a square-shaped container 26D may include four square-shaped top portions 38 arranged in a square. Referring to FIG. 2E, a rectangular-shaped container 26E may include six square-shaped top portions 38. Referring to FIG. 2F, a rectangular container 26F may include twelve square-shaped top portions 38.

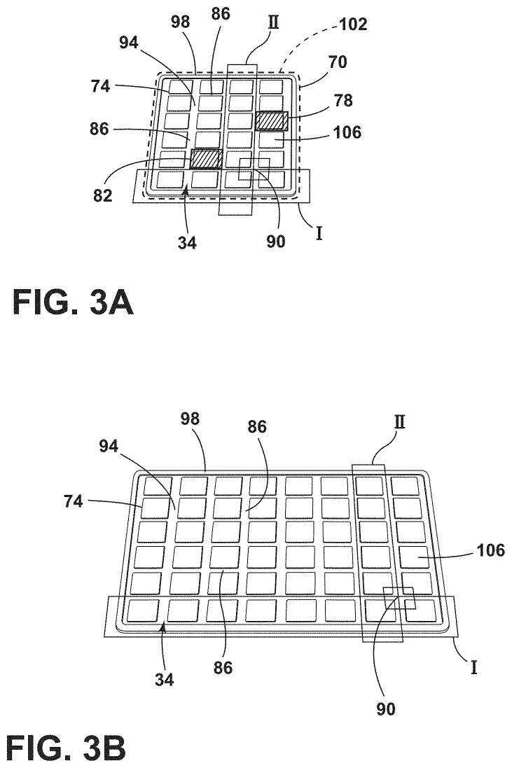

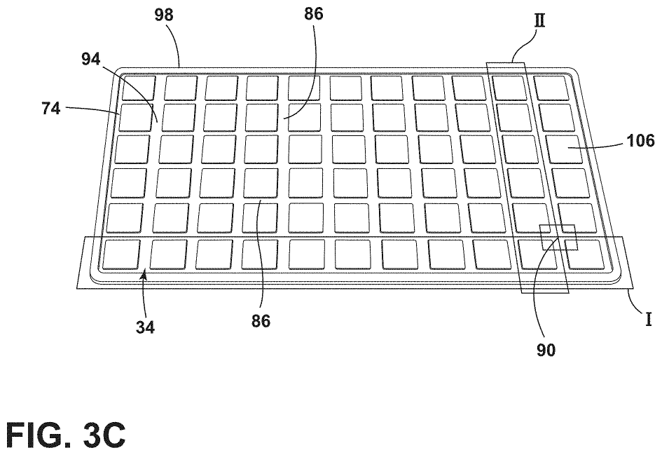

Referring to FIGS. 3A-3C, the vehicle floor 30 may include a panel 70. The panel 70 may be fixedly or removably attached to the vehicle floor 30. In various aspects, the panel 70 may include various materials. For example, the panel may include an injection molded plastic or a rubber. The materials of the panel 70 and the materials of the feet 62 of the containers 26 may allow for sliding of the feet 26 on the panel 70. The interface between the feet 62 and the panel 70 may be a low friction interface. A panel 70 may include a track assembly 74. A user may slide the containers 26 along the track assembly 74 to move the containers 26 from a first location 78 on the panel 70 to a second location 82 on the panel 70. A panel 70 may include substantially parallel tracks 86 disposed in a first direction I. The panel may also include substantially parallel tracks 86 disposed in a second direction II. In the example shown, the substantially parallel tracks 86 disposed in the first direction I may be transverse to the substantially parallel tracks 86 disposed in the second direction II. The intersection of a first track 86 and a second track 86 may define an attachment location 90. The feet 62 of a container 26 may be placed on an attachment location 90 in a disengaged position V. A container 26 may be coupled to the track assembly 74 on an attachment location 90 in an engaged position VI.

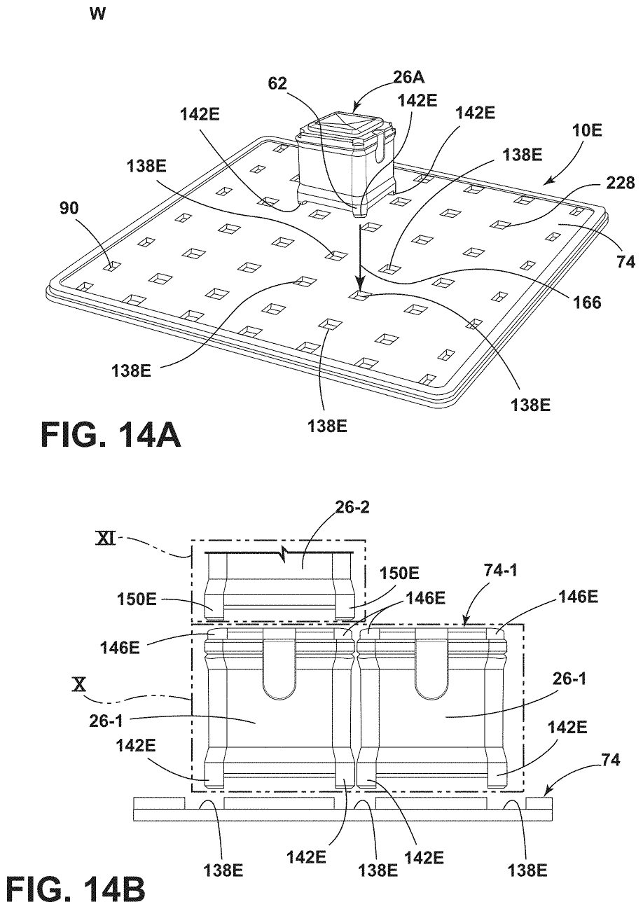

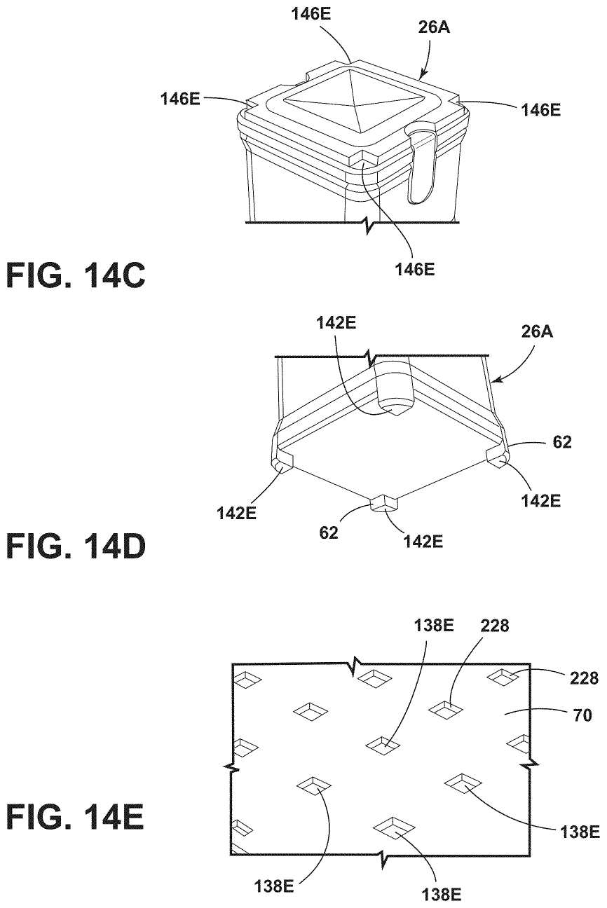

With continued reference to FIGS. 3A-3C, in various aspects, the tracks 86 may define recesses 94 in the panel 70 (FIGS. 3A-8, 9B, 10A-10B, 11A-11B, 11E, 12A-12B, 13A-13B, 13E, 15B, 17B). In various aspects, the tracks 86 and the panel 70 may form a substantially continuous surface (FIGS. 1, 14A).

With continued reference to FIGS. 3A-3C, the panel 70 may include a lip 98 disposed around the perimeter 102 of the panel 70. The lip 98 may be molded as part of the panel 70. The lip 98 may maintain the containers 26 on the panel 70. The lip 98 may minimize the likelihood that a container 26 may slide off of the panel 70.

Referring to FIG. 3A, the one or more square-shaped top portions 38 of containers 26 may be placed above locators 106 when the containers 26 are in an engaged position VI relative to the track assembly 74. The locators 106 may be part of a grid-like formation 34. The seven substantially parallel tracks 86 extending substantially transverse to the five substantially parallel tracks 86 may define the grid-like formation 34. The intersecting tracks 85 may be disposed proximate the corners of locators 106. The feet 62 of the containers 26 may be moved along the track assembly 74 disposed on the panel 70 between attachment locations 90. The containers 26 may be moved between attachment locations 90 by moving the containers 26 from a position substantially directly above one locator 106 to a position substantially directly above another locator 106. For example, a container 26 may be moved from a first location 78 disposed above one locator 106 to a second location 82 disposed above another locator 106. See, FIG. 3A.

Referring to FIG. 3B, according to another aspect, a panel 70 may include seven substantially parallel tracks 86 extending transverse to the nine substantially parallel tracks 86. The intersecting tracks 86 may define 48 container locators 106 on which square-shaped top portions 38 of containers 26 may be placed.

Referring to FIG. 3C, according to another aspect, a panel 70 may include seven substantially parallel tracks 86 extending transverse to twelve substantially parallel tracks 86. The intersecting tracks 86 may define 66 container locators 106 above which square-shaped top portions 38 of containers 26 may be placed. As such, panels 70 may be various sizes to accommodate different vehicle cargo storage space and to accommodate varying numbers of containers 26.

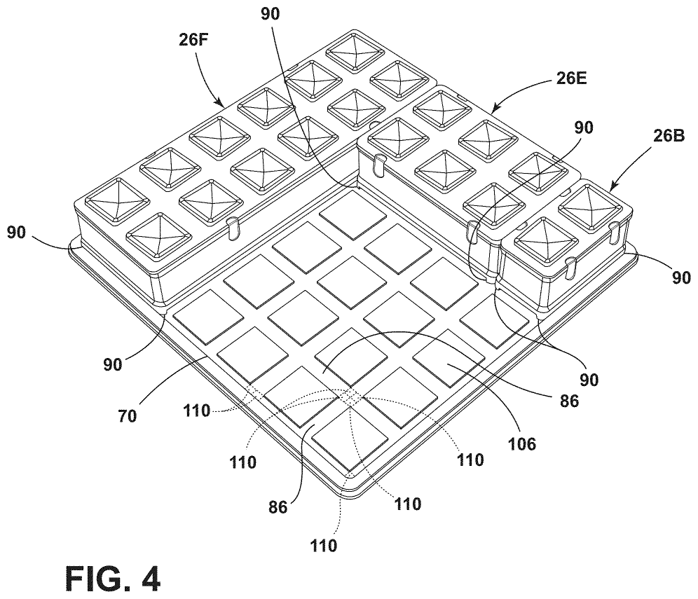

Referring to FIG. 4, an exemplary panel 70 may include 36 locators 106 defined by seven substantially parallel tracks 86 transverse to seven substantially parallel tracks 86. The containers 26 may be of various sizes (for example, the sizes of containers 26B, 26E, 26F). Each container 26 may include one or more square-shaped top portions 38. Each of the containers 26 may include four feet 62. Each foot 62 may be disposed in an attachment location 90 of the track assembly 74 when the container 26 is in the engaged position VI. An attachment location 90 may be formed by the intersection of two tracks 86. Each attachment location 90 may be divided into one or more attachment zones 110. Each attachment zone 110 may receive a foot 62 of a container 26. An attachment location 90 including one attachment zone 110 may be disposed in a corner of the panel 70. An attachment location 90 including two attachment zones 110 may be disposed along the perimeter 102 of the panel 70. See, FIG. 3. An attachment location 90 including four attachment zones 110 may be disposed in a central portion of the panel 70.

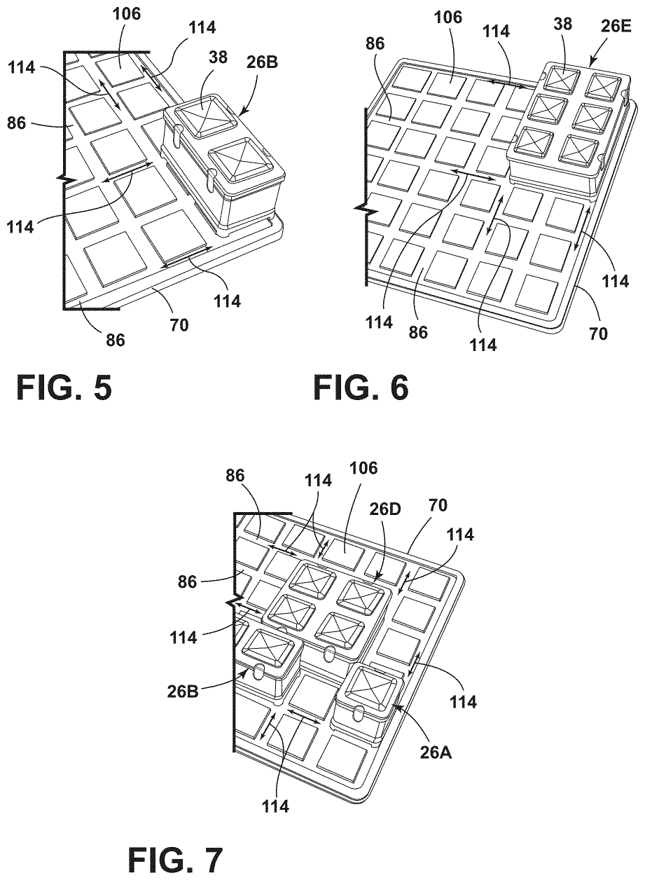

Referring to FIG. 5, a portion of a panel 70 is shown with a container 26B including two square-shaped top portions 38 disposed in a corner of the panel 70. The two square-shaped top portions 38 of the container 26 may be positioned substantially directly above the locators 106 in the panel 70. The container 26B may slide along the tracks 86 in the directions shown by arrows 114.

Referring to FIG. 6, a portion of a panel 70 is shown with a rectangular-shaped container 26E including six square-shaped top portions 38 disposed in a corner of the panel 70. The six square-shaped top portions 38 of the rectangular-shaped container 26E may be positioned substantially directly above the locators 106 in the panel 70. The rectangular-shaped container 26E may slide along the tracks 86 in the directions shown by arrows 114.

Referring to FIG. 7, a portion of the panel 70 is shown with a container 26A including one square-shaped top portion 38, a square-shaped container 26D including four square-shaped top portions 38, and a portion of a container 26 including two or more square-shaped top portions 38. The square-shaped portions of the containers 26 may be disposed above the locators 106. The containers 26 may slide along the tracks 86 in the directions shown by arrows 114.

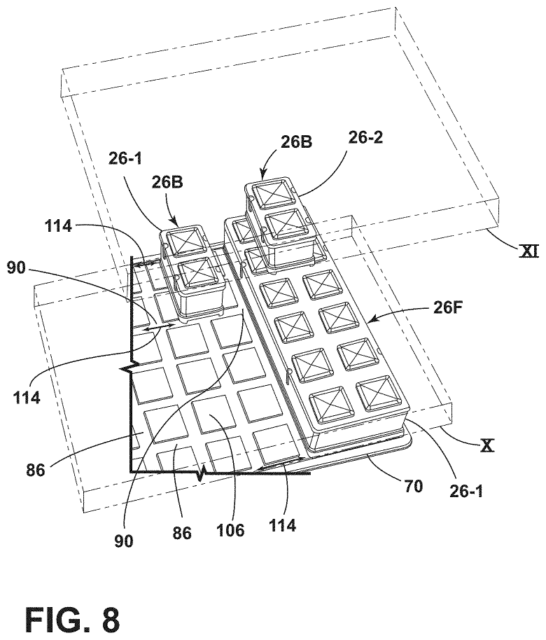

Referring to FIG. 8, a portion of the panel 70 is shown with a container 26B including two square-shaped top portions 38, a rectangular container 26F including twelve square-shaped top portions 38, and a container 26B including two square-shaped top portions 38 disposed above the container 26F including twelve square-shaped top portions 38. The twelve square- shaped top portions 38 may be disposed above the twelve locators 106 in the panel 70. The container 26B including two square-shaped top portions 38 may be disposed above four locators 106. As such, feet 62 of the container 26 including two square-shaped top portions 38 may be positioned between track attachment locations 90. The containers 26 may slide along the tracks 86 in the directions shown by arrows 114. The containers 26-1 disposed on the panel 70 may be in a first planar arrangement X of containers 26-1. The containers 26-2 disposed on the container 26-1 may be in a second planar arrangement XI of a container 26-2.

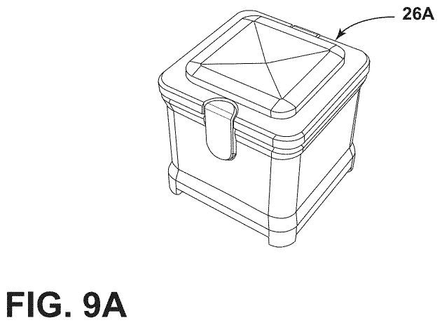

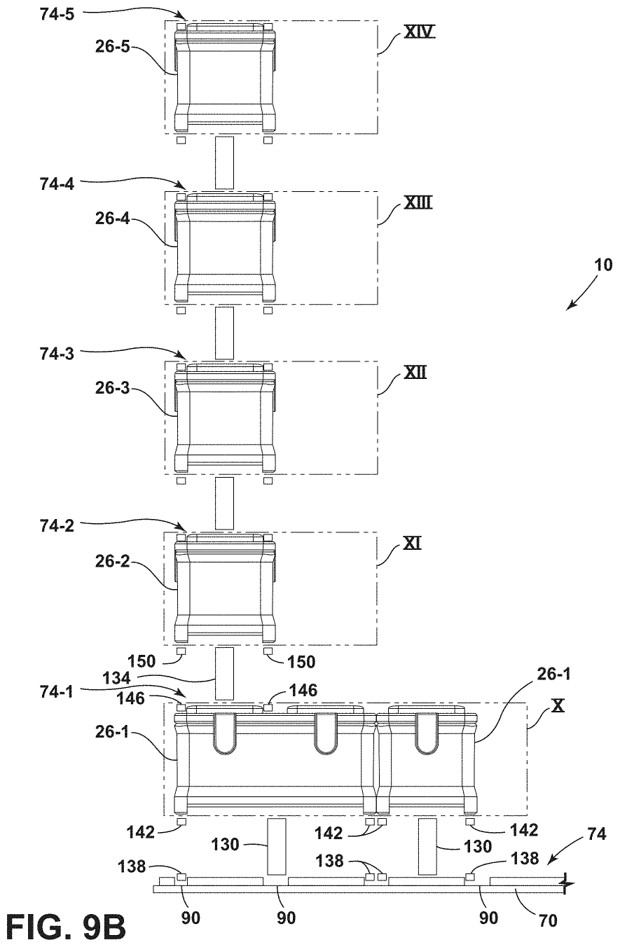

Referring to FIGS. 9A-9B an exemplary storage system 10 may include a track assembly 74, a first planar arrangement X of a container 26-1, and second planar arrangement XI of a container 26-2. The exemplary storage system 10 may also include third, fourth, and fifth planar arrangements of containers XII, XIII, and XIV. Additionally, it is contemplated that more than five planar arrangements of containers 26 may be used in various aspect of the disclosure.

With continuing reference to FIGS. 9A-9B, a container 26 may be disposed at an attachment location 90 of the track assembly 74. Containers 26-1 may secured to the track assembly 74 with a first attachment mechanism 130 disposed between the panel 70 and the container 26-1. The first attachment mechanism 130 may include a track attachment feature 138 and a lower attachment feature 142 of container 26-1. A second attachment mechanism 134 may secure a container 26-2 disposed in a second planar arrangement XI to the container 26-1 disposed in the first planar arrangement I. The second track attachment mechanism 134 may include an upper attachment feature 146 of the container 26-1 and a lower attachment feature 150 of the container 26-2.

With continued reference to FIGS. 9A-9B, the track assembly 74 may be disposed in the panel 70, in a vehicle floor 30, elsewhere in the vehicle 22, and/or outside the vehicle 22. A track assembly 74-1 may be defined by the first planar arrangement X of containers 26-1. A track assembly 74-2 may be defined by the second planar arrangement XI of containers 26-2. It is to be understood that additional layers of containers 26-3, 26-4, 26-5, and other layers may be included in the exemplary storage system 10. It is to be understood that additional planar arrangements XII of containers 26-3, XIII of containers 26-4, XIV of containers 26-5, and other planar arrangements may be added to the exemplary storage system 10. Additional track assemblies 74-3, 74-4, 74-5, and other track assemblies may be defined by the respective additional containers 26-3, 26-4, 26-5, and other containers.

Referring again to FIGS. 9A-9B, a system 10 for arranging containers 26 in a vehicle 22 includes a plurality of first containers (for example, containers 26-1) arranged in a first planar arrangement (for example, planar arrangement 26-1) in a vehicle cargo area 18 and including a first container lower attachment feature (for example, lower attachment feature 142), a first container upper attachment feature (for example, upper attachment feature 146). The system 10 for arranging containers 26 in a vehicle 22 also includes a plurality of second containers (for example, containers 26-2) arranged in a second planar arrangement (for example, planar arrangement 26-2) in a vehicle cargo area 18 and including a second container lower attachment feature (for example, lower attachment feature 150) and a second container upper attachment feature (for example, the upper attachment feature on top of the second container 26-1 that is like attachment 146). The system 10 for arranging containers 26 in a vehicle 22 also includes a panel including a track assembly 74 disposed in the vehicle 22 and including attachment locations 90 for receiving the plurality of first containers 26-1 on the track assembly 74 in engaged positions VI. The plurality of first containers 26-1 in disengaged positions V are movable along the track assembly 74 and between the attachment locations 90.

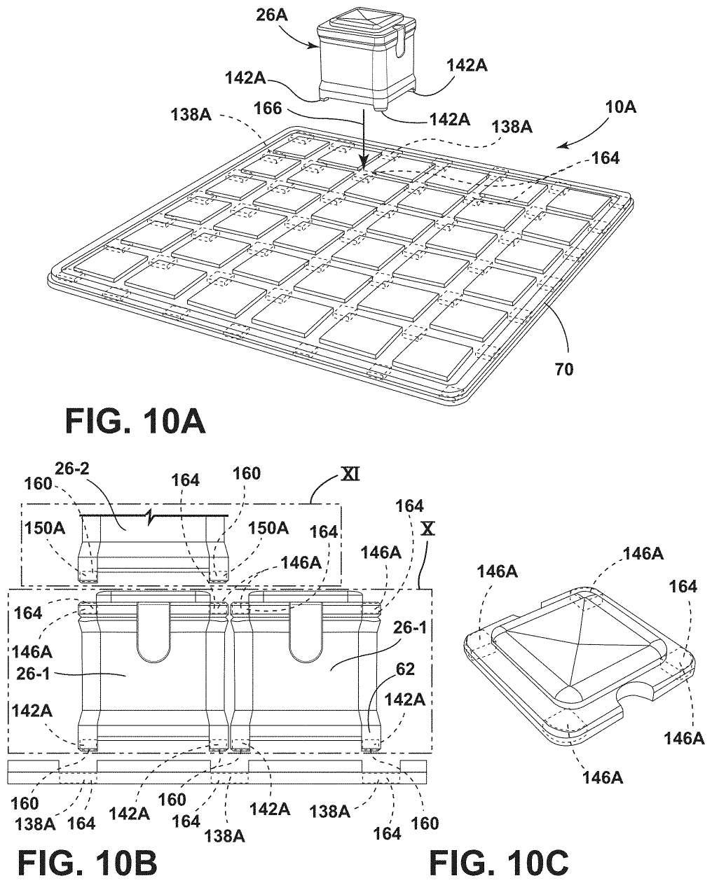

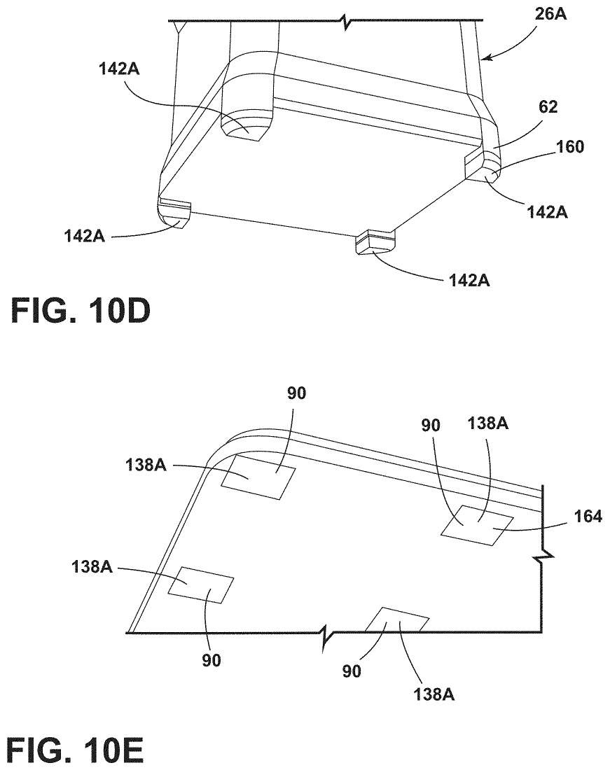

Referring to FIGS. 10A-10C, a system 10A may include track attachment features 138A with metals and/or magnets 164 and lower attachment features 142A with magnets 160. In the example shown, the attachment locations 90 may include track attachment features 138A that may have metals and/or magnets 164. The lower attachment features 142A disposed on the feet 62 of the containers 26-1 may include magnets 160. The metals and/or magnets 164 of the track attachment features 138A and the magnets 160 of the lower attachment features 142A may be positioned to attract to one another to secure the container 26-1 to the track assembly 74. If the container 26-1 is moved out of the magnetic field of the track attachment feature 138A, then the container 26-1 may disengage from the track attachment feature 138A. If the feet 62 with lower attachment feature 142A with magnets 160 are disposed on the track attachment feature 138A, then the container 26-1 may be in the engaged position VI relative to the track assembly 74. The container 26A may be moved in the direction shown by arrow 166 to attach the container 26A to the panel 70.

With continued reference to FIGS. 10A-10C, the upper attachment feature 146A may also include metals and/or magnets 164. A container 26-2 disposed above the container 26-1 may include a lower attachment feature 150A with magnets 160. The upper attachment feature 146A of the container 26-1 may engage with the lower attachment feature 150A of the container 26-2 in the engaged position VI to secure the container 26-2 to the container 26-1. As such, the geometries of the upper attachment feature 146A and the lower attachment feature 150A may be substantially similar to the geometries of the track attachment feature 138A and the lower attachment feature 142A. The upper attachment feature 146A may be disposed in the corners of the lid 54. It is to be understood that the first planar arrangement X of containers 26-1 may define a first track assembly 74-1 on the upper surface of the containers 26-1. Containers 26-2 in the second planar arrangement XI of containers 26-2 may slide along the first track assembly 74-1 on the containers 26-1 of the first planar arrangement X of containers 26-1.

With reference to FIG. 10D, the lower attachment features 142A may be disposed on the feet 62 of the container 26. The lower attachment features 142A may include magnets 160 embedded in the feet 62 of the container 26A.

With reference to FIG. 10E, track attachment features 138A may include metals and/or magnets 165 having ferrous metal. Ferrous metal may be positioned in the underside of the panel 70 at the attachment locations 90.

Referring to FIGS. 10A-10E, a variety of different arrangements of magnetic materials may be used in containers 26-1 and 26-2 and the panel 70 to achieve magnetic engagements between the containers 26-1, 26-2 and the panel 70.

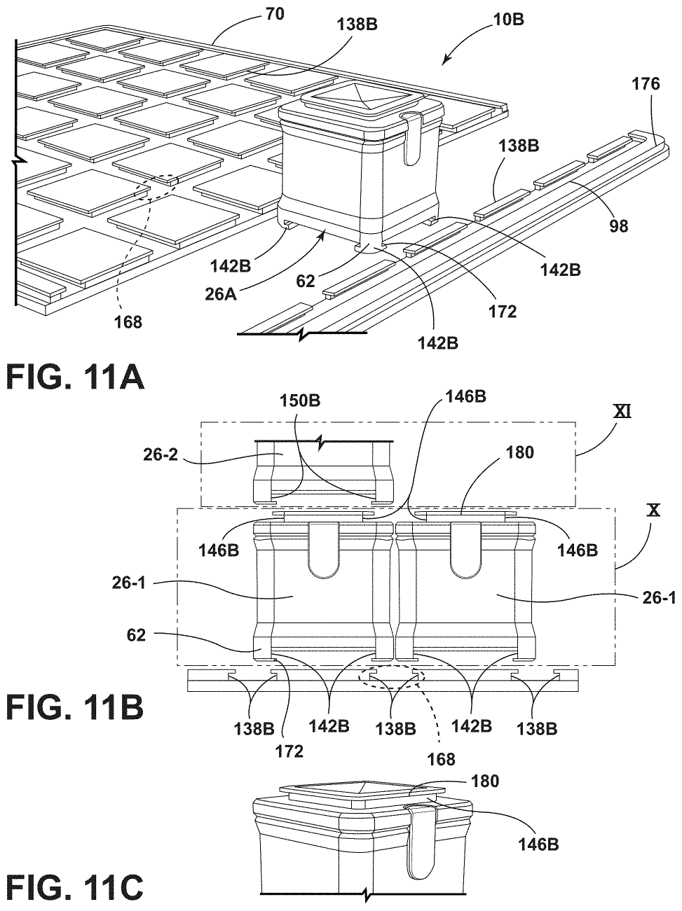

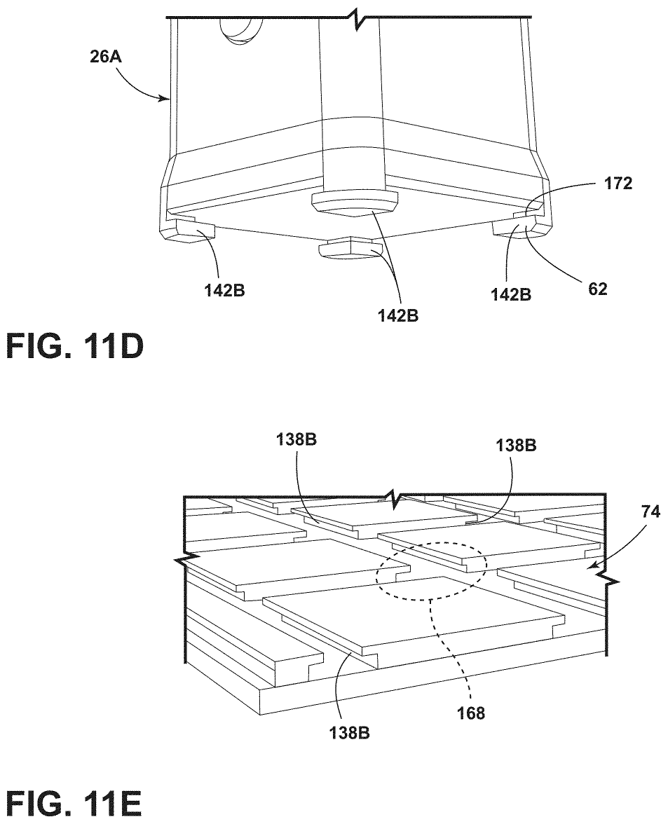

With reference to FIGS. 11A-11C, a system 10B may include track attachment features 138B that include T-shaped slots 168 and lower attachment features 142B that include feet 62 with flanges 172. The feet 62 with flanges 172 of the container 26-1 may mate with the T-shaped slots 168 in the panel 70 to form an engagement between the container 26-1 and the panel 70. The containers 26-1 may slide along the tracks 86 while the feet 62 with flanges 172 are in the T-shaped slots 168. The lip 98 disposed around the perimeter 102 (see, FIG. 3A) of the panel 70 may be positioned at the loading area of a vehicle 22 to minimize the likelihood of a container 26-1 sliding out of the vehicle 22. In various aspects, a border portion 176 of the panel 70 may be detachable from the panel 70 to allow the feet 62 with flanges 172 of the containers 26-1 to be inserted into the T-shaped slots 168 of the track assembly 74.

With continued reference to FIGS. 11A-11C, the upper attachment feature 146B of the container 26-1 may also include T-shaped slots 168 defined by a raised portion 180 of the two containers 26-1. The T-shaped slots 168 may receive the lower attachment feature 150B of the container 26-2. The lower attachment feature 150B may include feet 62 with flanges 172. As such, the geometries of the upper attachment feature 146B and the lower attachment feature 150B may be substantially similar to the geometries of the track attachment feature 138B and the lower attachment feature 142B. The upper attachment feature 146B may be in a raised portion 180 of the square-shaped top portion 38 of the lid 54. It is to be understood that the first planar arrangement X of containers 26-1 may define a track assembly 74-1 on the upper surface of the containers 26-1 in the first planar arrangement X of containers 26-1. Containers 26-2 in the second planar arrangement XI of containers 26-2 may slide along the track assembly 74-1 on the upper surface of the containers 26-1 in the first planar arrangement X.

Referring now to FIG. 11D, a container 26A may include a lower attachment features 142B that are feet 62 with flanges 172. In the aspect shown, the flanges 172 may extend inward toward the center of the container 26-1 and below the container 26-1.

Referring now to FIG. 11E, the track assembly 74 may include T-shaped slots 168 within which the feet 62 with flanges 172 may slide. The flanges 172 of the feet 26 may extend into the T-shaped slots 168 of the tracks 86.

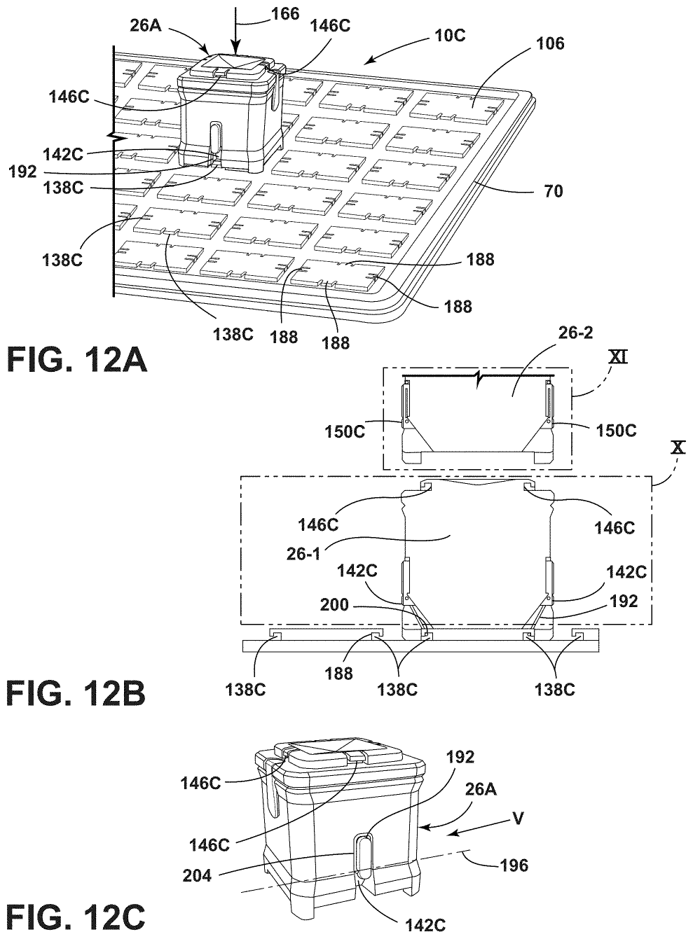

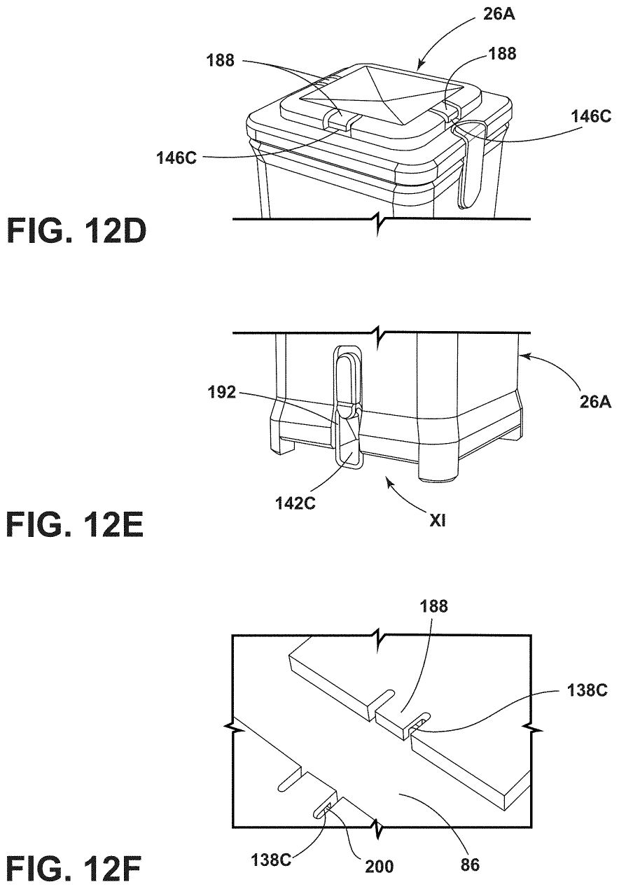

With reference to FIGS. 12A-12C, a system 10C may include track attachment features 138C having a hook tab 188 and a lower attachment features 142C having a clip lock 192. The clip lock 192 may be rotatable about an axis of rotation 196 disposed in a side of the container 26. The clip lock 192 may rotate about the axis of rotation 196 between a stored position in the container 26 and an engaged position VI with the hook tab 188 in the panel 70. When the clip lock 192 is in the stored position, then the container 26 may be carried or moved with the clip lock 192 within the indentation 204 of the container 26. When the clip lock 192 is in the stored position, the clip lock 192 may be in the disengaged position V.

With continued reference to FIGS. 12A-12C, the locators 106 in the panel 70 may include hook tabs 188 on each of the four sides of the locators 106. In the disengaged position V of the container 26A, the clip locks 192 may not be engaged with the hook tabs 188. In the engaged position VI of the container 26A, the clip locks 192 may be engaged with the hook tabs 188. Each hook tab 188 may include a channel 200 for receiving a clip lock 192. The channel 200 may be disposed on the underside of the hook tab 188. In the example shown, the clip locks 192 may be located on two opposing sides of the container 26A. The container 26A may be moved in the direction shown by arrow 166 to attach the container 26A to the panel 70.

With continued reference to FIGS. 12A-12C, the upper attachment feature 146C of the container 26-1 disposed in the first planar arrangement X of containers 26-1 may include a hook tab 188 for receiving a clip lock 192. The container 26-2 disposed atop of the container 26-1 in the first planar arrangement X may include a lower attachment feature 150C that may include a clip lock 192. It is to be understood that the first planar arrangement X of containers 26-1 may define a first track assembly 74-1 on the upper surface of the containers 26-1 in the first planar arrangement X. Containers 26-2 in the second planar arrangement XI may slide along the track assembly 74-1 on the upper surface of the containers 26-1.

Referring to FIG. 12D, a container 26A may include an upper attachment feature 146C with a hook tab 188. Hook tabs 188 may be disposed on four sides of the container 26A.

Referring to FIG. 12E, a container 26A may include a lower attachment feature 142C. The clip lock 192 is in the engaged position VI to engage with a track attachment feature 138C that may be the hook tab 188.

Referring to FIG. 12F, the track assembly 74 may include the hook tabs 188 that are disposed along the sides of the tracks 86. Channels 200 are disposed below the hook tabs 188.

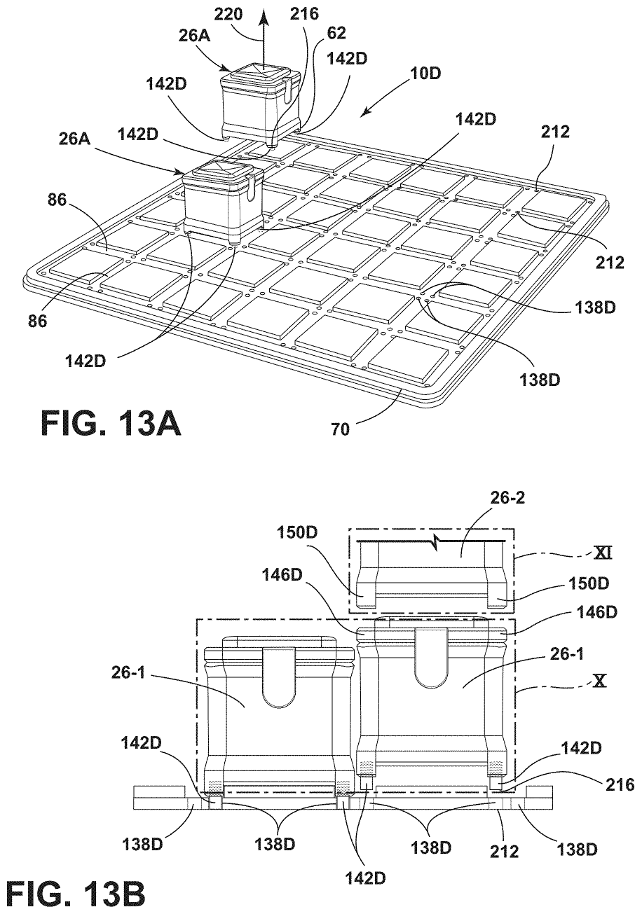

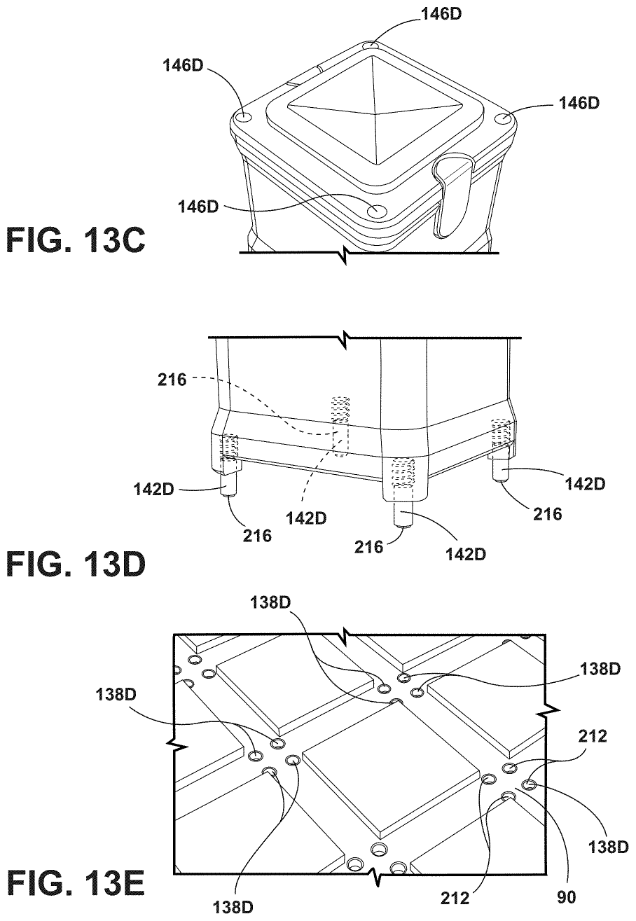

With reference to FIGS. 13A-13C, a system 10D may include track attachment feature 138D including a hole 212 and a lower attachment feature 142D including a spring-loaded pin 216. Spring-loaded pins 216 may be disposed in the feet 62 of the container 26. The holes 212 may be disposed in the attachment locations 90 of the panel 70. Each attachment location 90 may include four attachment zones 110 (FIG. 4). Each attachment zone 110 may receive a spring-loaded pin 216 of a container 26. The spring-loaded pins 216 of the container 26 may be designed to extend downward into holes 212 in the panel 70 when the spring-loaded pins 216 are positioned over the holes 212 as the container 26 slides along the tracks 86 and over the holes 212. The container 26 may be lifted in the direction shown by arrow 220 to remove the container 26 from the panel 70.

Referring now to FIGS. 13A-13C, the upper attachment feature 146D of the container 26-1 disposed in the first planar arrangement X of containers 26-1 may include holes 212 for receiving spring-loaded pins 216. The container 26-2 disposed atop the container 26-1 in the first planar arrangement X of containers 26-1 may include a lower attachment feature 150D that includes a spring-loaded pin 216. It is to be understood that the first planar arrangement X of containers 26-1 may define a track assembly 74-1 on the upper surface of the containers 26-1 of the first planar arrangement X of containers 26-1. Containers 26-2 in the second planar arrangement XI of containers 26-2 may slide along the track assembly 74-1 on the upper surface of the containers 26-1 in the first planar arrangement X of containers 26-1.

Referring to FIG. 13D, the lower attachment features include spring-loaded pins 216. The spring-loaded pins 216 may be in an extended position.

Referring to FIG. 13E, the attachment locations 90 may be at the intersections of tracks 86. An attachment location 90 disposed in a center of the panel 70 may include four attachment zones 110 (FIG. 4). Each attachment zone 110 may include a hole 212 for receiving a spring-loaded pin 216 of a container 26.

Referring now to FIGS. 14A-14C, a system 10E may include a track attachment feature 138E that may be a detent 228 and a lower attachment feature 142E that may be a foot 62. In the engaged position VI of the container 26-1, the weight of the container 26-1 may cause the container 26-1 to remain in the detent 228. In the disengaged position V of the container 26A, the feet 62 may be outside of the detents 228. The container 26-1 may be slidable along the track assembly 74 disposed on the panel 70. Each detent 228 may be disposed at an attachment location 90 on the panel 70. Each detent 228 may include four attachment zones 110 (FIG. 4). Each attachment zone 110 may receive a foot of a container 26.

Referring again to FIGS. 14A-14C, the upper attachment feature 146E of the container 26-1 disposed in the first planar arrangement X of containers 26-1 may include detents 228 for receiving feet 62. The container 26-2 disposed atop the container 26-1 in the first planar arrangement X of containers 26-1 may include a lower attachment feature 150E that includes a foot 62. It is to be understood that the first planar arrangement X of containers 26-1 may define a track assembly 74-1 on the upper surface of the containers 26-1 of the first planar arrangement X of containers 26-1. Containers 26-2 in the second planar arrangement XI of containers 26-2 may slide along the track assembly 74-1 on the upper surface of the containers 26-1 in the first planar arrangement X of containers 26-1.

Referring now to FIG. 14D, a container 26 may include four feet 62 that may be received by four detents 228.

Referring now to FIG. 14E, a panel 70 may include detents 228 for receiving the feet 62 of containers 26.

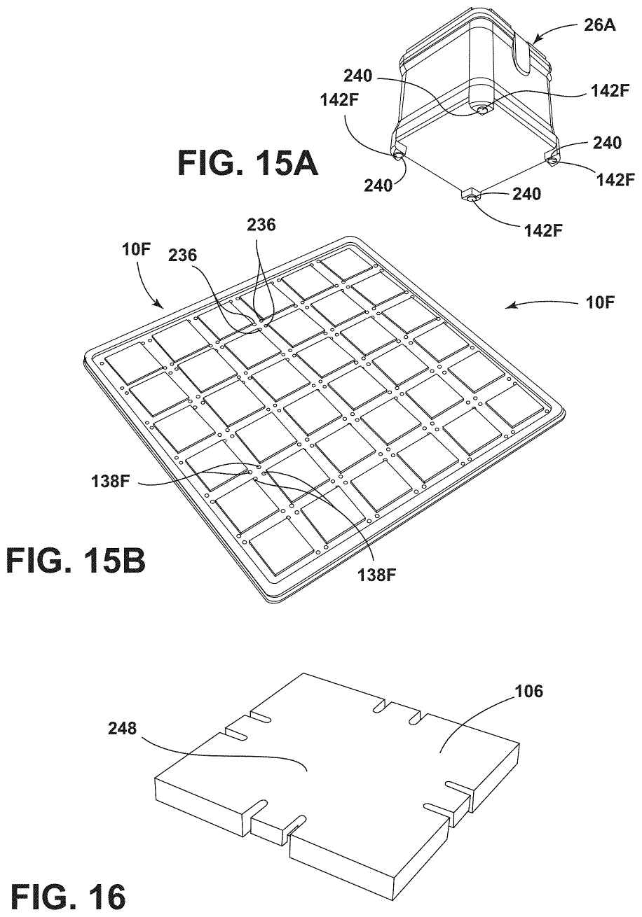

Referring now to FIGS. 15A-15B, a system 10F may include a track attachment feature 138F having a charging feature 236 and a lower attachment feature 142F having a charge receiver 240. A charging feature 236 may be disposed in the panel 70 at an attachment location 90. The charging feature 236 may include a battery, an electrical outlet, a wire harness, or other power source. If the container 26 is engaged with the panel 70 at the attachment location 90, the container 26 may receive power from the charging feature 236 through the charge receivers 240 in the feet 62 of the container 26. The power supplied by the charging feature 236 may power the container 26. In one aspect, the container 26 may be a refrigerator, and the charging feature 236 may power the refrigerator. It is also contemplated that containers 26-1, 26-2 that may be arranged in respective first planar arrangements X of containers 26-1 and second planar arrangements XI of containers 26-2 may be structured so that power is transferred from the track attachment feature 138F through the lower attachment feature 142F, through an upper attachment feature 146 (see FIG. 9B), and to a lower attachment feature 150 (see FIG. 9B). This power transfer may occur for additional layers of containers (for example, containers 26-3, 26-4, and 26-5 in respective third, fourth, and fifth planar arrangements of containers XII, XIII, and XIV). As such, a substantially vertical arrangement of containers 26-1, 26-2, 26-3, 26-4, and 26-5 may be powered by the track attachment feature 138F.

With reference to FIG. 16, individual tiles 248 may be used as locators 106. The individual tiles 248 may be manufactured and installed in a vehicle 22 as separate components. The tiles 248 may be assembled to any vehicle floor 30, panel 70, other structure in a vehicle 22, or a structure proximate a vehicle 22. As such, the tiles 248 may be used to construct a panel 70 beyond a vehicle interior 14, and the tiles 248 may extend the system for attaching a container 26 to a panel 70 outside of a vehicle 22.

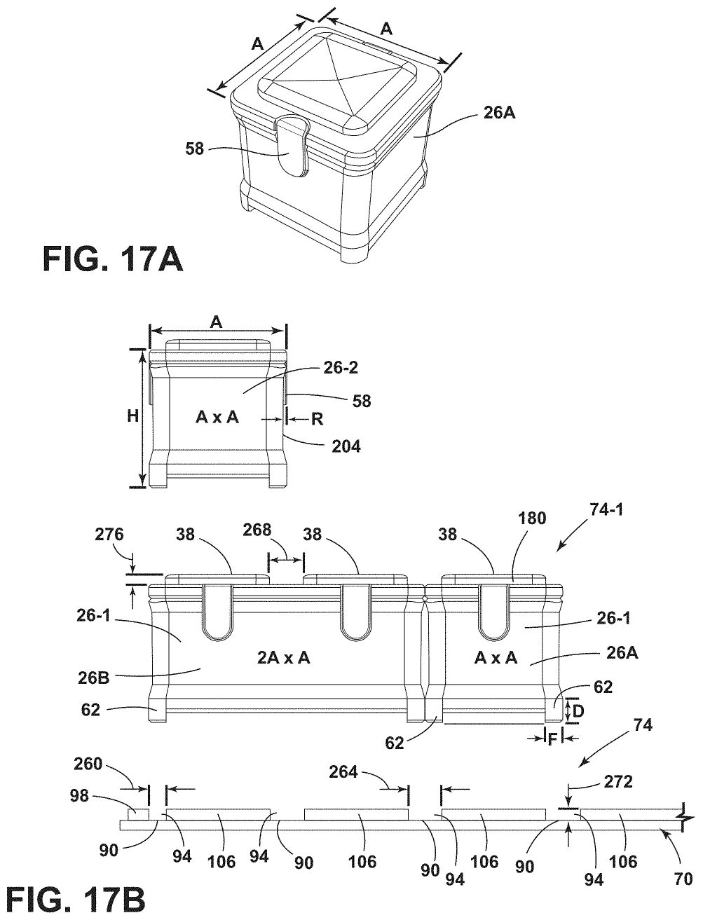

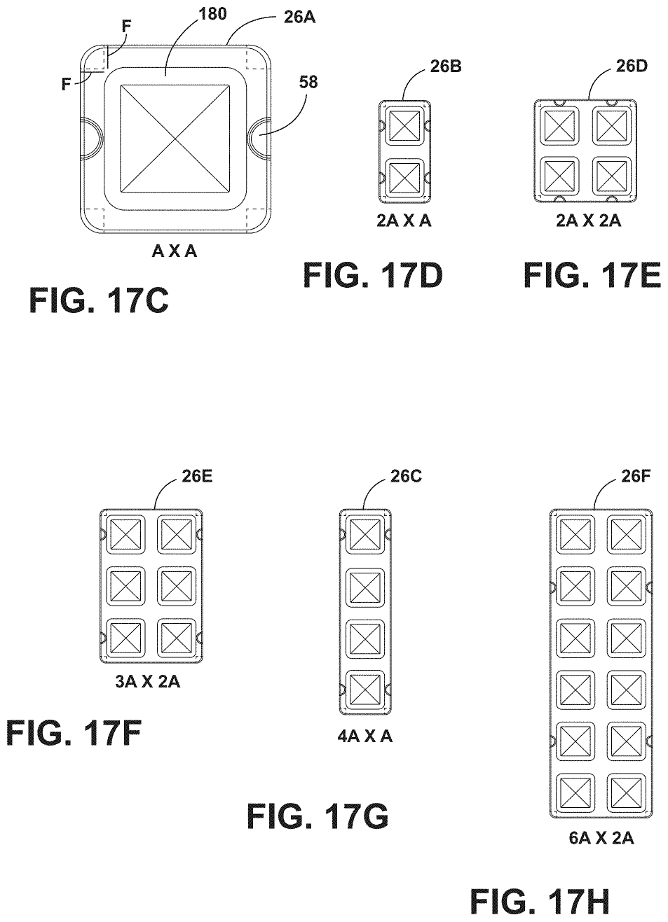

Referring now to FIGS. 17A-17B, the exemplary storage system 10 of FIGS. 9A-9B includes exemplary dimensions. An approximate cross-sectional area of container 26A may be designated by dimension A×A. Dimension A may indicate the length of a container 26A and the width of the container 26A. In one exemplary storage system, the dimension A may be in the range of between 10 centimeters and 50 centimeters and ideally approximately 25 centimeters. Referring to FIG. 17B, the dimension H may indicate the height of the container 26A. In one aspect of the disclosure, the dimension H may be equal to the dimension A designating the length and the width of the container 26. In another aspect of the disclosure, the dimension H may be less than the dimension A. In yet another aspect of the disclosure, the dimension H may be greater than the dimension A. In aspects of the disclosure that include a track assembly 74-1 disposed on containers 26-1, the dimension H of the containers 26 may be substantially constant. For example, the containers 26-1 of the first planar arrangement X may have substantially equal dimensions H so that the track assembly 74-1 disposed on the containers 26-1 may be substantially level.

With continued reference to FIGS. 17A-17B, the dimension R may refer to a recess or indentation 204 in the side of the container 26. The indentation 204 designated by dimension R may provide space for storing the handles 58 of the container 26. The handles 58 may be generally sub-flush with a substantially vertical edge of the container 26. The dimension R may include a tolerance for maintaining the handles 58 sub-flush relative to the substantially vertical edge of the container 26.

Referring again to FIGS. 17A-17B, the container 26-2 may be disposed above the container 26-1. The container 26B may include an approximate cross-sectional area 2A×A. The container 26B may include two square-shaped top portions 38. A container 26A with approximate cross-sectional area A×A may be disposed next to the container 26B with the approximate cross-sectional area 2A×A. The dimension D may designate a height of the feet 62 on the containers 26-1. The dimension F may designate the width of the feet 62 of the containers 26-1. The panel 70 may include lip 98. Locators 106 may extend upward from the panel 70. Recesses 94 between the locators 106 may define the tracks 86 that the containers 26 may slide along.

With continuing reference to FIGS. 17A-17B, the distance 260 between the lip 98 and the locator 106 may be designed to receive a foot 62 having a width F. The dimension 264 designating the distance between two locators 106 may be designed to receive two adjacent feet 62, each having a width F. The dimension 268 between the two raised portions 180 may be designed to receive two adjacent feet 62. The dimension 272 may designate the height of the locator 106. The height 272 of the locator 106 may be designed so that a container 26-1 may be slidable over the locator 106 as it moves along the track assembly 74. The height 276 of the raised portion 180 may be designed so that the container 26-2 may be slidable over the raised portion 180 as it moves over the track assembly 74-1.

Various factors may affect the dimensions (A, H, R, F, D, 260, 264, 268, 272, 276, and other dimensions) of a storage system 10. These factors may include component materials and component construction. Different components of the storage system 10 may have different tolerances. Tolerances may be dependent on the construction and the materials of the components.

Referring to FIG. 17C, a top elevational view of the container 26A is shown. The container 26A may include a raised portion 180 and handles 58. Each foot 62 may include widths designated by the dimensions F, F. The container 26A may have an approximate cross-sectional surface area A×A.

Referring to FIG. 17D, a container 26B with two square-shaped top portions 38 may have an approximate cross-sectional surface area designated by dimension 2A×A.

Referring to FIG. 17E, a square-shaped container 26D with four square-shaped top portions 38 may have an approximate cross-sectional surface area designated by dimension 2A×2A.

Referring to FIG. 17F, a rectangular-shaped container 26E with six square-shaped top portions 38 may have an approximate cross-sectional surface area designated by dimension 3A×2A.

Referring to FIG. 17G, an elongated container 26C with four square-shaped top portions 38 may have an approximate cross-sectional surface area designated by dimension 4A×A.

Referring to FIG. 17H, a rectangular container 26F with twelve square-shaped top portions 38 may have an approximate cross-sectional surface area designated by dimension 6A×2A.

As such, FIGS. 17A-17H depict an exemplary storage system of containers 26 and a panel 70. The containers 26 may have one or more uniform square-shaped top portions 38 (for example, A×A, 2A×A, 2A×2A, 3A×2A, 4A×A, 6A×2A). As such, the square-shaped top portions 38 of the containers 26 may be positioned above the uniformly distributed locators 106.

It is to be understood that the track attachment features 138 of the panels 70 described may be incorporated directly into a vehicle floor 30, in a panel 70 that may be separate from a vehicle floor 30, or in another substrate that may be attached to a vehicle floor 30. The track attachment features 138 may be in a vehicle interior or outside of a vehicle 22.

It is to be understood that the location of the containers 26 within the vehicle 22 may include locations in addition to the vehicle floor 30. For example, the containers 26 may be suspended from a vehicle ceiling, a vehicle wall, other vehicle structure, or structure proximate a vehicle 22.

A variety of advantages may be obtained by use of the present discprolosure. A container 26 may be engaged to a panel 70, a vehicle floor 30, and/or another container 26 to minimize sliding of the container 26 during vehicle use. As such, vehicle cargo may be securely stored. The containers 26 may provide a system 10 with numerous container 26 and panel 70 options. The containers 26 and the panel 70 may include various sizes, configurations, materials, and/or colors. A container 26 may move along a track assembly 74. A container 26 may slide and move as allowed by a track assembly 74 to allow a user to easily position and reposition a container 26 in a cargo area 18 while minimally lifting a container 26. Containers 26 may be rearranged in the storage system 10 with minimal or negligible use of tools. Containers 26 may be stacked on the panel 70 or vehicle floor 30. Containers 26 may be stacked on other containers 26 in the same manner that they are stacked on the vehicle floor 30. A container 26 may be stackable with other containers 26 or accessories that may include substantially similar attachment mechanisms 130, 134. Multiple containers 26 may occupy the same track 86 or intersection of tracks 86. Containers 26 may be arranged in a repeatable pattern that may be scalable for various vehicle footprints such as Sport Utility Vehicles, vans, trucks, and other vehicles. Containers of various heights may be utilized in a storage system 10.

It is to be understood that the storage system 10 may be used in connection with a vehicle outside of a vehicle interior. It is to be understood that the storage system 10 may also be used in connection with other means of transporting cargo such as trains, airplanes, ships, and other transportation vehicles. It is to be understood that the storage system 10 may be used in applications other than vehicles 22.

It is to be understood that variations and modifications can be made on the aforementioned structure without departing from the concepts of the present invention, and further it is to be understood that such concepts are intended to be covered by the following claims unless these claims by their language expressly state otherwise.

1. A storage system for a vehicle, comprising:
a track assembly disposed on a vehicle floor and including:
a first track disposed transverse to a second track;
one or more locators disposed in a grid-like formation, wherein the grid-like formation is defined by the first track and the second track;
a plurality of containers positionable in an engaged position or a disengaged position relative to the track assembly and each including;
one or more feet coupled to a bottom-corner portion of the plurality of housings, the one or more feet having a foot height, wherein the foot height is at least equal to a locator height of the one or more locators; and
one or more square-shaped top portions positioned substantially above the one or more locators, the one or more square-shaped top portions having a top portion height that is at most equal to the foot height.

2. The storage system for a vehicle of claim 1, wherein the plurality of containers are positionable in a planar arrangement substantially parallel to the vehicle floor.

3. The storage system for a vehicle of claim 2, further comprising:
an attachment location disposed at an intersection of the first track and the second track.

4. The storage system for a vehicle of claim 3, further comprising:
a track attachment feature disposed at the attachment location.

5. The storage system for a vehicle of claim 4, wherein the track attachment feature includes one or more attachment zones.

6. The storage system for a vehicle of claim 5, wherein each of the one or more attachment zones is configured to receive the one or more feet of one of the plurality of containers.

7. The storage system for a vehicle of claim 6, wherein each of the plurality of containers includes a lower attachment feature positionable in an engaged position or a disengaged position relative to the track attachment feature.

8. The storage system for a vehicle of claim 7, wherein each of the plurality of containers includes an upper attachment feature.

9. The storage system for a vehicle of claim 8, wherein the upper attachment feature is substantially similar to the track attachment feature.

10. The storage system for a vehicle of claim 9, wherein each of the plurality of containers having the upper attachment feature defines a plurality of first containers disposed in a first planar arrangement of first containers coupled to the track assembly, and further comprising a plurality of second containers disposed in a second planar arrangement of second containers.

11. The storage system for a vehicle of claim 10, wherein the second planar arrangement of second containers is disposed on top of the first planar arrangement of first containers.

12. The storage system for a vehicle of claim 11, wherein each of the plurality of second containers disposed in the second planar arrangement of second containers include a lower attachment feature that is positionable in an engaged position or a disengaged position relative to the upper attachment feature disposed on each of the plurality of first containers disposed in the first planar arrangement of first containers.

13. The storage system for a vehicle of claim 10, wherein the each of the plurality of first containers disposed in the first planar arrangement of first containers are linearly slidable along the track assembly.

14. A storage system for a vehicle comprising:
a first container;
a track assembly having a plurality of attachment zones arranged in a grid-like formation for receiving the first container; and
a first attachment mechanism disposed between the first container and the track assembly, wherein the first attachment mechanism includes a lower attachment feature disposed on the first container and a track attachment feature disposed in the track assembly, wherein the lower attachment feature includes at least one foot extending outward from the first container, the at least one foot having at least one flange coupled to a bottom surface of the at least one foot, and wherein the at least one flange is confisured to operably couple to the track attachment feature, and wherein the first attachment mechanism may be in an engaged position to secure the first container to the track assembly, and wherein the first attachment mechanism may be in a disengaged position to release the first container from the track assembly.

15. The storage system for a vehicle of claim 14, further comprising:
a second container disposed on top of the first container; and
a second attachment mechanism disposed between the first container and the second container and movable between an engaged position to secure the second container to the first container and a disengaged position to release the second container from the first container.

16. The storage system for a vehicle of claim 15, wherein the first container is one of a plurality of first containers disposed in a first planar arrangement on the track assembly, wherein the second container is one of a plurality of second containers disposed in a second planar arrangement above the first planar arrangement, and wherein the first container and the second container are the same size and shape.

17. The storage system for a vehicle of claim 16, wherein a panel disposed on a vehicle floor defines the track assembly, and wherein the plurality of first containers are linearly sliedable along the track assembly and the plurality of second containers are linearly slideable along a top portion of the plurality of first containers.

18. The storage system for a vehicle of claim 17, further comprising:
a first track assembly defined by the first planar arrangement; and
a second track assembly defined by the second planar arrangement.

19. A system for arranging containers in a vehicle comprising:
a plurality of first containers arranged in a first planar arrangement in a vehicle cargo area and including:
a first container lower attachment feature having at least one first foot extending outward from the first container, the at least one first foot having at least one first flange coupled to a bottom surface of the at least one first foot; and
a first container upper attachment feature;
a plurality of second containers arranged in a second planar arrangement in a vehicle cargo area and including:
a second container lower attachment feature having at least one second foot extending outward from the plurality of second containers, the at least one second foot having at least one second flange coupled to a bottom surface of the at least one second foot; and
a second container upper attachment feature; and
a panel including a track assembly disposed in the vehicle and including:
attachment locations for receiving the plurality of first containers on the track assembly in engaged positions, wherein the plurality of first containers in disengaged positions are movable along the track assembly and between the attachment locations, and wherein the attachment locations include a track attachment feature that operably couples to the at least one first flange and the at least one second flange.

20. The system for arranging containers in a vehicle of claim 19, wherein the track assembly and the attachment locations are arranged in a grid-like formation, and wherein the attachment locations further define one or more T-shaped slots, the T-shaped slots being configured to engage with the at least one first flange and the at least one second flange.
